(19) United States
(12) Patent Application Publication
(10) Pub. No.: US 2024/0353083 A1
(43) Pub. Date: Oct. 24, 2024

(54) LIGHT-GATHERING UNIT, LIGHT-EMITTING DEVICE AND LIGHT-EMITTING SYSTEM

(71) Applicant: Goertek Optical Technology Co., Ltd., Weifang (CN)

(72) Inventor: SHIYU ZHANG, Shandong (CN)

(73) Assignee: Goertek Optical Technology Co., Ltd., Weifang (CN)

(21) Appl. No.: 18/760,658

(22) Filed: Jul. 1, 2024

Related U.S. Application Data
(63) Continuation of application No. PCT/CN2021/143903, filed on Dec. 31, 2021.

(51) Int. Cl. F21V 7/06; F21V 7/00

(52) U.S. Cl. CPC F21V 7/06; F21V 7/0083

(57) ABSTRACT

Disclosed are a light-gathering unit, a light-emitting device, and a light-emitting system. The light-gathering unit comprises: a reflecting member, the reflecting member having a light entrance and a light exit, a reflective surface of the reflecting member being a paraboloid of revolution, and a portion of incident light exiting in a first direction after being reflected by the reflective surface; a collimating lens, a portion of the incident light exiting in the first direction after passing the collimating lens; and a symmetric axis of the paraboloid of revolution coincides with an optical axis of the collimating lens. The present disclosure can gather the light emitted from the light source and reflect it to a predetermined position through combined action of the collimating lens and the reflective surface, thereby improving the light-gathering efficiency of the light-gathering unit.

### CROSS-REFERENCE TO RELATED APPLICATIONS

The present disclosure claims priority to International Application No. PCT/CN2021/143903, filed on Dec. 31, 2021, which is hereby incorporated by reference in its entirety.

### TECHNICAL FIELD

The present disclosure relates to the technical field of light-gathering components, and particularly to a light-gathering unit, a light-emitting device and a light-emitting system.

### BACKGROUND

In daily life, artificial light sources used to emit light may be regarded as point light sources, such as incandescent lamps or light-emitting diodes. The above point light sources emit divergent light but cannot directly emit gathered light, and thus a general point light source needs to be used in conjunction with a light-gathering component, so as to gather the divergent light emitted by the point light source and reflect it to a predetermined position through the light-gathering component, thereby increasing utilization rate of the divergent light. However, the light-gathering efficiency of the existing light-gathering components are still not high, which leads to the waste of the light source. For example, the divergent light emitted by the light source escapes from the light-gathering component, and the escaped light is not reflected to the predetermined position, leading to a loss of the light source.

### SUMMARY

The present disclosure is directed to provide a light-gathering unit, a light-emitting device and a light-emitting system for solving the problem of low light-gathering efficiency of the existing light-gathering unit.

In order to achieve the purpose of the present disclosure, the present disclosure provides the following technical solutions:

In a first aspect, the present disclosure provides a light-gathering unit, comprising:
a reflecting member, the reflecting member having a light entrance and a light exit, a reflective surface of the reflecting member being a paraboloid of revolution, and a portion of incident light exiting in a first direction after being reflected by the reflective surface;
a collimating lens, a portion of the incident light exiting in the first direction after passing the collimating lens;
a symmetric axis of the paraboloid of revolution coincides with an optical axis of the collimating lens.

Optionally, an included angle between a connecting line between the focus of the reflective surface and the light entrance, and the symmetric axis is less than or equal to 90 degrees.

Optionally, the light entrance is smaller in diameter than the light exit.

Optionally, a connector is provided between the reflecting member and the collimating lens, and is made of a light-transmitting material.

Optionally, the connector is a portion of a spherical wall, whose spherical center coincides with the focus of the reflective surface.

Optionally, the reflecting member, the connector and the collimating lens are integrally molded solid structures, an outer surface of the reflecting member being the reflective surface.

Optionally, the collimating lens has a maximum light-transmitting outer contour, and an extension of a connecting line between the focus of the paraboloid of revolution and any point on the maximum light-transmitting outer contour points to the reflective surface.

In a second aspect, the present disclosure provides a light-emitting device, comprising a light source and the above light-gathering unit, the light source being located at a focus of the reflective surface.

In a third aspect, the present disclosure provides a light-emitting system, comprising a plurality of the above light-emitting devices, all of the light-emitting devices being arranged in an array.

Optionally, further comprising a substrate, the substrate is made of a light-transmitting material, a first surface of the substrate is provided with a plurality of first convex lenses arranged in an array, a second surface of the substrate is provided with a plurality of second convex lenses arranged in an array, the first surface of the substrate faces away from the second surface of the substrate, and the light exit of the light-emitting device is provided facing towards the first convex lenses.

Optionally, a focus of the first convex lens is located on the second convex lens, and a focus of the second convex lens is located on the first convex lens.

One technical effect of the present disclosure is that through the combined action of the collimating lens and the reflective surface, it is possible to gather the light emitted from the light source and reflect it to a predetermined position, thereby improving the light-gathering efficiency of the light-gathering unit.

### BRIEF DESCRIPTION OF THE DRA WINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

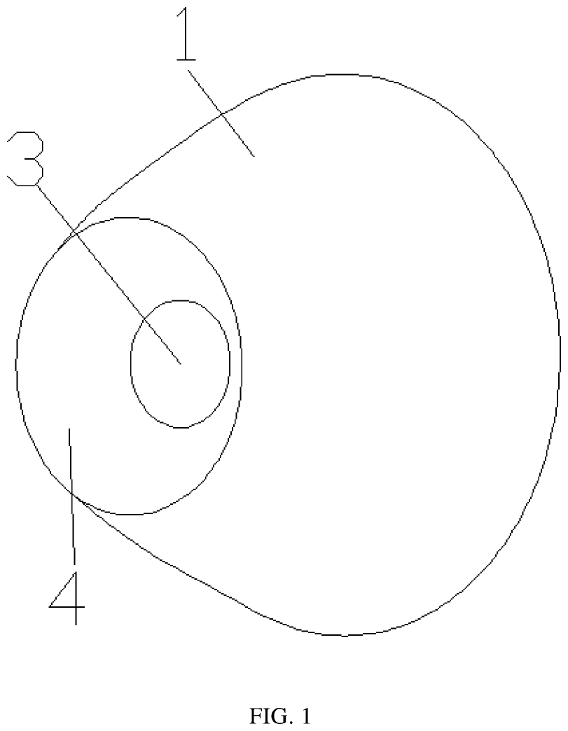

FIG. 1 is a structural diagram of a first embodiment of a light-gathering unit provided by the present disclosure;

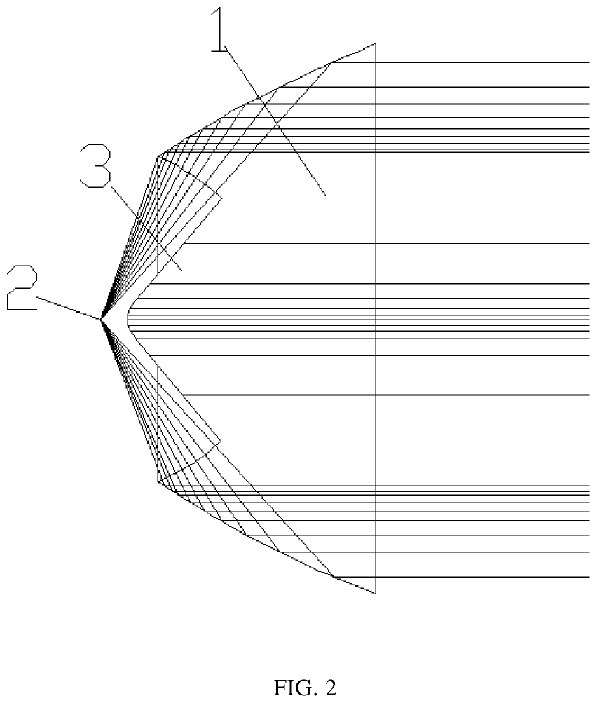

FIG. 2 is a schematic diagram of a light path of a light-gathering unit provided by the present disclosure;

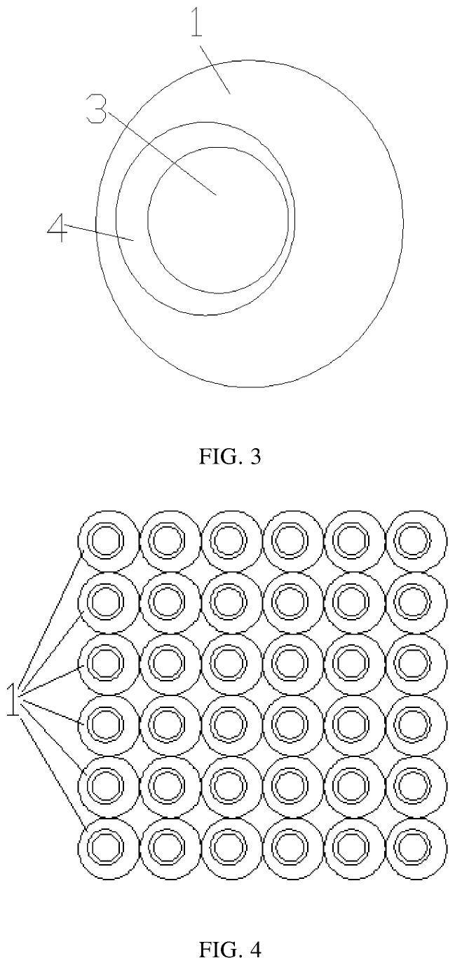

FIG. 3 is a structural diagram of a second embodiment of a light-gathering unit provided by the present disclosure;

FIG. 4 is a structural diagram of an array arrangement of a light-gathering unit provided by the present disclosure;

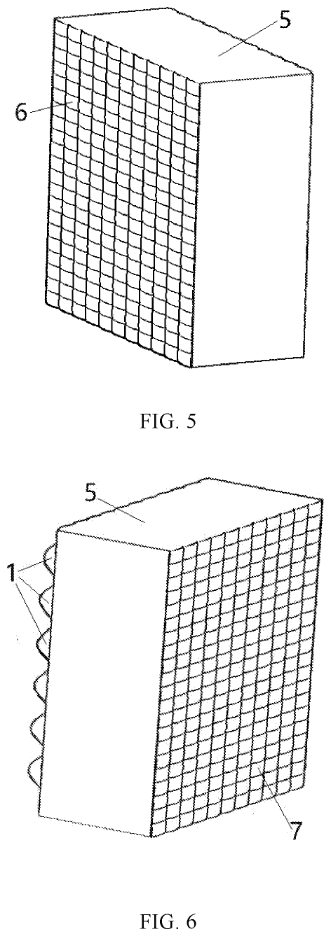

FIG. 5 is a structural schematic diagram of a substrate;

FIG. 6 is a structural schematic diagram of a light-emitting system.

### DESCRIPTION OF REFERENCE SIGNS

1, reflecting member; 2, focus; 3, collimating lens; 4, spherical wall; 5, substrate; 6, first convex lens; 7, second convex lens.

### DETAILED DESCRIPTION

In order to make the purpose, technical solutions and advantages of the embodiments of the present disclosure clearer, technical solutions in the embodiments of the present disclosure are described below with reference to the accompanying drawings in the embodiments of the present disclosure. Obviously, the described embodiments are merely some rather than all of the embodiments of the present disclosure. All other embodiments, acquired by those of ordinary skill in the art based on the embodiments of the present disclosure without any creative work, should fall into the protection scope of the present disclosure.

In a first aspect, as shown in FIGS. 1 and 3, the present disclosure provides a light-gathering unit comprising a reflecting member 1 and a collimating lens 3. The reflecting member 1 is used for reflecting light emitted from a non-central part of the point light source, and enables the light emitted from the non-central part of the point light source to be reflected to a predetermined position. For example, the divergent light enters from the light entrance of the reflecting member 1, and after being reflected by the reflecting member 1, the resulting light, which is relatively gathered, is emitted via the light exit of the reflecting member 1 to a predetermined position. Wherein, the predetermined position refers to being in a certain defined area. For example, an area in front of the light-emitting end of the emitting element at a certain distance from the light-emitting end of the emitting element is a predetermined position, and the reflecting member 1 reflects part of the light emitted in all directions by the light source to the predetermined position. Wherein, a port at one end of the reflective surface is the light entrance of the reflecting member 1, and a port at the other end of the reflective surface is the light exit of the reflecting member 1.

The reflecting member 1 has a reflective surface in the shape of a paraboloid of revolution, and part of the incident light is emitted in a first direction after being reflected by the reflective surface. For example, an end face at a first side of the reflecting member 1 may be provided with a groove, the whole inner wall of which forms a parabolic structure, the inner wall of the groove is coated with a light reflecting material or provided with a reflective film, and the light reflecting material or the reflective film reflects the light toward a first direction so as to reflect the light to the predetermined position first. The diameter of the portion of the above groove adjacent to the end face at the first side is greater than the diameter of the portion of the groove distal to the end face at the first side. The light source may be provided in a space with a small diameter of the groove so that the light emitted from the light source to the surroundings is reflected to the predetermined position. Wherein, the reflecting member 1 may also be a shell-like structure integrally formed as the parabolic structure.

Further, since the reflective surface is the paraboloid of revolution, the reflective surface has a focus 2. When the light source is provided on the focus 2 of the reflective surface, the light emitted from the light source to the surroundings is reflected by the reflective surface in the parabolic shape, thereby forming parallel light. Therefore, the reflecting member 1 may prevent the divergent light emitted from the light source to the surroundings from illuminating outside the predetermined position, thereby achieving the effect of further gathering the light. For example, the same light source emits two light rays in different directions, and after the two light rays are reflected by the reflective surface, if the two light rays are not parallel, then only one light ray illuminates the predetermined position or neither of the two light rays illuminates the predetermined position, resulting in a waste of the light source. By contrast, providing the light source on the focus 2 of the reflective surface enables the reflective surface to reflect the light, and the reflected light forms collimated parallel light and is emitted to the predetermined position, which may play a role in avoiding the waste of the light source. Moreover, this form of arrangement does not have high requirements for the light source but has strong applicability.

The light-gathering unit disclosed herein further comprises a collimating lens 3, and a portion of the incident light is emitted toward the first direction after passing through the collimating lens 3, and emitted to the predetermined position. Specifically, the light emitted by the light source toward its light-gathering unit is directed toward the collimating lens 3 and is emitted parallelly via the light exit of the reflecting member 1 after passing through the collimating lens 3. Wherein, the collimating lens 3 is capable of transforming the light emitted by the light source into parallel light to prevent the light from illuminating outside the predetermined position, thereby enhancing the gathering degree of the lights. For example, in the case that the collimating lens 3 is not provided, the light source emits two light rays that are not parallel to each other, where one of these light rays may not illuminate the predetermined position, or even both of these light rays may not illuminate the predetermined position, causing waste of the light source. Furthermore, an anti-reflective coating may be applied to the outer surface of the collimating lens 3 to prevent light from being reflected on the surface of the collimating lens, thereby increasing the light transmittance of the collimating lens 3, which is conducive to making more light rays pass through the collimating lens 3 and ensures that the present disclosure has a high light-gathering efficiency.

Wherein, the symmetric axis of the paraboloid of revolution coincides with the optical axis of the collimating lens 3, which allows the reflecting member 1 and the collimating lens 3 to reasonably distribute the light emitted by the light source, that is, the collimating lens 3 refracts the central light emitted by the light source, and the reflecting member 1 reflects the light emitted by the light source to its surroundings, which enables a more even distribution of the light emitted by the light-gathering unit. At the same time, the above features enable a symmetrical structure of the light-gathering unit of the present disclosure, which is convenient for manufacturing. Wherein, the optical axis refers to the central line of the light beam or the symmetric axis of the optical system.

As shown in the light path diagram of FIG. 2, through the combined action of the collimating lens 33 and the reflective surface, the present disclosure may gather the light emitted from the light source to its surroundings and the light emitted by the light source to its front, thereby improving the light-gathering efficiency of the present disclosure. Moreover, when the light source is located at the focus 2 of the reflective surface, the light-gathering unit of the present disclosure may enable the gathered light to parallelly illuminate the predetermined position, which prevents the lights emitted from the light source that are not parallel to each other from being illuminated outside the predetermined position, avoids the waste of the light source, and further improves the light-gathering efficiency of the light-gathering unit.

Optionally, an included angle between the connecting line between the focus 2 of the reflective surface and the light entrance, and the symmetric axis is less than or equal to 90 degrees. The present implementation limits the position of the focus 2 of the reflective surface. When the included angle between the connecting line between the focus 2 of the reflective surface and the light entrance, and the symmetric axis is equal to 90 degrees, the focus 2 is located in the plane where the light entrance of the reflecting member 1 is located. When the light source is located at the focus 2, that is, when the light source is located in the plane where the light entrance of the reflecting member 1 is located, the light-gathering unit of the present disclosure may collect 180 degrees of light emitted by the light source, and the light beyond the 180-degree range emitted by the light source cannot be collected. Therefore, the present implementation may collect the light emitted by the light source with the maximum efficiency.

When the included angle between the connecting line between the focus 2 of the reflective surface and the light entrance, and the symmetric axis is less than 90 degrees, the position of the focus 2 is on the side of the plane where the light entrance of the reflecting member 1 is located, distal to the light-gathering unit. When the light source is located at the focus 2, that is, when the light source is located on the side of the plane where the light entrance of the reflecting member 1 is located, distal to the light-gathering unit, the light-gathering unit of the present disclosure may collect the light of less than 180 degrees emitted by the light source. Although the light emitted by the light source cannot be collected with the maximum efficiency in this case, this scenario can provide a certain distance between the light source and the plane where the light entrance of the reflecting member 1 is located, refraining from having to extend the light entrance of the reflecting member 1 to the light source, which avoids the problem of small radian of the reflective surface near the light source and facilitates the processing and manufacturing of the reflecting member 1.

Optionally, the light entrance is smaller in the diameter than the light exit. Under ideal conditions, the light entrance of the reflecting member 1 collects light from point light sources, that is, the diameter of the light entrance of the reflecting member 1 does not have to be made large to collect the light from the point light source. The light exit is used for emitting the light gathered by the reflecting member 1 from the point light source to achieve uniform illumination and other purposes. Therefore, the diameter of the light exit of the reflecting member 1 is relatively large, which may increase the illuminated area.

Optionally, a connector is provided between the reflecting member 1 and the collimating lens 3, and is made of a light-transmitting material. That is to say, the collimating lens 3 is fixed on the reflecting member 1 by means of the connector, making the light-gathering unit of the present disclosure a separate component from the light source. When the light source or the light-gathering unit needs to be repaired or replaced due to damage, the damaged light source or light-gathering unit may be directly replaced, which facilitates the maintenance and replacement of the components.

Optionally, the connector is part of a spherical wall 4, and the spherical center of the spherical wall 4 coincides with the focus 2 of the reflective surface. That is to say, the focus 2 of the reflective surface is on the side of the connector that is recessed, and the collimating lens 3 is located on the spherical wall 4. When the light source is located at the focus 2, that is, when the light source is at the spherical center of the spherical wall 4, the light emitted by the light source may pass through the spherical wall 4 without changing the light transmission direction, that is, the light will not be refracted when passing through the spherical wall 4, such that after the light emitted by the light source at the focus 2 of the reflective surface passed through the reflective surface, the light may be emitted parallelly through the light exit of the reflecting member 1, which is conducive to improving the gathering degree of the light. Further, an anti-reflective coating may be applied to both the collimating lens 3 and the spherical wall 4, so as to increase the light transmittance and ensure that the present disclosure has a high light-gathering efficiency.

Optionally, the reflecting member 1, the connector and the collimating lens 3 form an integrally molded solid structure, and an outer surface of the reflecting member 1 is the reflective surface. That is to say, the whole light-gathering unit of the present disclosure is a single integral structure, and the material of the entire light-gathering unit is a light-transmitting material. At this time, the light emitted by the light source may enter into the reflecting member 1 made of the light-transmitting material and form total internal reflection or total reflection inside the reflecting member 1, such that the light entering into the reflecting member 1 is reflected at the outer surface of the parabolic-shaped reflecting member 1, thereby forming parallel light rays inside the reflecting member 1 and emitting them from the reflecting member 1. This avoids the need to provide the light-reflecting material or the reflective film on the parabolic surface, simplifying the manufacturing process of the reflecting member 1.

Further, the light exit of the reflecting member 1 is an exit plane, and the exit plane is perpendicular to the optical axis. That is to say, the entire end surface of the light exit of the reflecting member 1 is the exit plane, and the exit plane is perpendicular to the optical axis. When the parallel light is emitted from inside of the reflecting member 1, it may enable the emitted light to refrain from being refracted, and ensure that the light emitted from inside of the reflecting member 1 is also parallel to the optical axis. Further, the anti-reflective film is provided on the exit plane at the light exit of the reflecting member 1, so as to improve light transmittance and ensure that the present disclosure has a higher light-gathering efficiency. Wherein, the outer surface of the reflecting member 1 of the solid structure may also be provided with a reflective film, which may assist the total reflection of the reflecting member 1, and further increase the reflection efficiency of the reflecting member 1. At the same time, the reflective film on the outer surface of the reflecting member 1 may also play a role of protecting the reflecting member 1.

Further, a groove may be provided on a reflective light-exit endface, the inner diameter of the groove is the same as the outer diameter of the collimating lens 3, and the bottom of the groove is the collimating lens 3. Such a structure may save the materials and reduce the cost.

Optionally, the collimating lens 3 has a maximum light-transmitting outer contour, and an extension of a connecting line between the focus 2 of the paraboloid of revolution and any point on the maximum light-transmitting outer contour points to the reflective surface. The light emitted by the light source in front of it will form the parallel light after passing through the collimating lens 3, and the light emitted by the light source to its surroundings will form the parallel light after being reflected by the reflective surface of the reflecting member 1. However, between the light emitted by the light source in front of it and the light emitted by the light source to its surroundings, there may be some light emitted by a part of the light sources that has not passed through the collimating lens 3 nor has it been illuminating on the reflective surface of the reflecting member 1. This part of the light will not be transformed into the parallel light and emitted via the light exit of the reflecting member 1, instead, it will be emitted via the light exit of the reflecting member 1 at an angle to the optical axis, resulting in waste of the light source. By satisfying the condition that the extension of the connecting line from the focus 2 to any point on the maximum light-transmitting outer contour points to the reflective surface, it is possible to make the above part of the light completely emitted toward the reflective surface, so as to be transformed into parallel light and emitted via the light exit of the reflecting member 1, therefore avoiding the waste of the light source and improving the light-gathering efficiency.

In other words, the feature that extension of a connecting line between the focus 2 of the paraboloid of revolution and any point on the maximum light-transmitting outer contour points to the reflective surface determines a distance between the focus 2 and one end of the reflective surface distal to the focus 2, that is, it ensures the length of the parabola that extends in the direction distal to the focus 2, such that the light between the light emitted by the light source in front of it and the light emitted by the light source to its surroundings may be emitted toward the reflective surface and transformed into the parallel light, avoiding the waste of the light source.

It should be noted that the maximum light-transmitting outer contour of the collimating lens 3 is relative to the focus 2 of the reflective surface. Specifically, a straight line is drawn toward the reflective surface via the focus 2 of the reflective surface, and the straight line is rotated around the focus 2 of the reflective surface, when the line contacts with the collimating lens 3, an intersection point is created between the straight line and the collimating lens 3. With the center of the collimating lens 3 being the center and the distance from the center to the intersection point being the radius, the contour formed on the collimating lens 3 is the maximum light-transmitting outer contour. Under normal circumstances, the maximum light-transmitting outer contour of the collimating lens 3 is the largest frame of the collimating lens 3.

In a second aspect, the present disclosure provides a light-emitting device comprising a light source and the above light-gathering unit, and the light source is located at a focus 2 of the reflective surface. The light-emitting device of the present disclosure may gather the divergent light sources to emit parallel light rays, thereby enhancing the gathering degree of the light.

In a third aspect, the present disclosure provides a light-emitting system, which, as shown in FIG. 4, comprises a plurality of the above light-emitting devices, and all of the light-emitting devices are arranged in an array. The light-emitting system of the present disclosure may provide a sufficient number of parallel light rays. Wherein, the array formed by the light-emitting device may be arranged into different shapes, such as circles or polygons.

Optionally, as shown in FIGS. 5 and 6, further comprising a substrate 5, the substrate 5 is made of a light-transmitting material, a first surface of the substrate 5 is provided with a plurality of first convex lenses 6 arranged in an array, a second surface of the substrate 5 is provided with a plurality of second convex lenses 7 arranged in an array, the first surface of the substrate 5 faces away from the second surface of the substrate 5, and the light exit of the light-emitting device is provided facing towards the first convex lenses 6. The interaction between the first lens and the second lens may make the light emitted by the light-emitting system of the present disclosure more uniform. Further, a focus 2 of the first convex lens 6 is located on the second convex lens 7, and a focus 2 of the second convex lens 7 is located on the first convex lens 6, which makes the light emitted by the light-emitting system of the present disclosure more uniform. Wherein, the radius of curvature of the first convex lens 6 may be the same as that of the second convex lens 7.

Further, the first convex lens 6, the second convex lens 7, and the substrate 5 may be integrally molded. The substrate5 may be provided in various required shapes, such as a circle, a triangle, or other user-defined shapes.

The above disclosure is merely a preferred embodiment of the present disclosure and is not intended to limit the scope of the present disclosure. Those of ordinary skill in the art will understand that all or a portion of the process of implementing the above embodiments and equivalent changes made in accordance with the claims of the present disclosure are still within the scope of the present disclosure.

1. A light-gathering unit, comprising:
a reflecting member, the reflecting member having a light entrance and a light exit, a reflective surface of the reflecting member being a paraboloid of revolution, and a first portion of incident light exiting in a first direction after being reflected by the reflective surface;
a collimating lens, a second portion of the incident light exiting in the first direction after passing the collimating lens; and
a symmetric axis of the paraboloid of revolution coincides with an optical axis of the collimating lens.

2. The light-gathering unit according to claim 1, wherein an included angle between a connecting line between a focus of the reflective surface and the light entrance, and the symmetric axis is less than or equal to 90 degrees.

3. The light-gathering unit according to claim 1, wherein the light entrance is smaller in diameter than the light exit.

4. The light-gathering unit according to claim 1, wherein a connector is provided between the reflecting member and the collimating lens, and is made of a light-transmitting material.

5. The light-gathering unit according to claim 4, wherein the connector is a portion of a spherical wall, whose spherical center coincides with a focus of the reflective surface.

6. The light-gathering unit according to claim 5, wherein the reflecting member, the connector, and the collimating lens are integrally molded solid structures, an outer surface of the reflecting member being the reflective surface.

7. The light-gathering unit according to claim 1, wherein the collimating lens has a maximum light-transmitting outer contour, and an extension of a connecting line between a focus of the paraboloid of revolution and any point on the maximum light-transmitting outer contour points to the reflective surface.

8. A light-emitting device, comprising a light source and the light-gathering unit according to claim 1, the light source being located at a focus of the reflective surface.

9. A light-emitting system, comprising a plurality of light-emitting devices according to claim 8, all of the light-emitting devices being arranged in an array.

10. The light-emitting system according to claim 9, comprising a substrate, wherein the substrate is made of a light-transmitting material, a first surface of the substrate is provided with a plurality of first convex lenses arranged in an array, a second surface of the substrate is provided with a plurality of second convex lenses arranged in an array, the first surface of the substrate faces away from the second surface of the substrate, and the light exit of the light-emitting device is provided facing towards the first convex lenses.

11. The light-gathering unit according to claim 10, wherein each focus of the first convex lenses is located on one of the second convex lenses, and each focus of the second convex lenses is located on one of the first convex lenses.
